(19) United States
(12) Patent Application Publication
(10) Pub. No.: US 2003/0202838 A1
(43) Pub. Date: Oct. 30, 2003

(54) Fingertip fluid and its applicator

(76) Inventors: Yao Sun, Montgomery Village, MD (US); Ding Yin Li, Montgomery Village, MD (US); Jiao Sun, Yangzhou (CN)

Correspondence Address: YAO SUN, 18009 Royal Bonnet Circle, Montgomery Village, MD, 20886, US

(21) Appl. No.: 10/418,865

(22) Filed: Apr. 21, 2003

(30) Foreign Application Priority Data
Apr. 27, 2002 (CN) 02112939.8

(51) Int. Cl. B43K 5/00

(52) U.S. Cl. 401/202; 401/196

(57) ABSTRACT

A fluid for moisturizing fingertip and an applicator for uniformly dispensing the liquid to the skin of fingertip. The fingertip moistener fluid is to ease paper-handling tasks. By applying the fluid one fingertips, the user will get a better grip when handling slippery materials such as paper or money.

The fluid compositions contain more than 50% (by weight) water and at least one of the following ingredient: surfactants, alcohols (including polyhydric alcohols), organic acids, esters, hydrocarbons, antibacterial agents such as 2,4,4′-trichloro-2′-hydroxydiphenyl ether, preservatives and fragrances.

The applicator is composed of a supply bottle with a porous plastic applicator disc attached to the flexible top of supply bottle which has a small open hole reaching to the bottom of the supply bottle by a drainage tube. When the porous applicator disc on the flexible top is pressed down, the volume of the supply bottle is reduced and the fingertip fluid is forced out from the bottom of the supply bottle through the drainage tube and the porous applicator disc; and when the bottle is released, fingertip fluid trapped within the applicator disc interior returns to the supply bottle avoiding unwanted evaporation.

### BACKGROUND OF THE INVENTION

1. Field of the Invention

The present invention relates to a series of liquids used for moisturizing the skin of fingertip and a device for storing a supply of said liquid and dispensing the liquid on the skin of user's fingertips uniformly and conveniently. By applying the fingertip fluid on fingertips, the user will get a better grip when handling slippery materials such as paper or money.

2. Description of the Prior Art

Almost everyone had such an experience: fingers were too dry to separate slippery money bills or open a plastic film bag. A slide happens between fingers and the subjects which you want separate while the frictional force between the skin of the fingertip and the subjects is weaker than the frictional force between the subjects. When skin is wet, the texture is soft, the frictional force between the subject and the skin is stronger than that when the skin is dry. It is easy to count money, to open plastic film bag when the fingertip texture is soft because the skin contains enough moisture. These easy things become difficult when the skin loses its natural moisture on the skin's surface thereby causing the cuticle to become hard and slippery. Two kinds of products are commercially available which are directed to moisturizing the skin of fingertip for better grip when handling slippery materials. One is water applicators, another is wax form moisteners which contain almost no water. While these products achieve varying degrees of success as moisturizing agents, research continues in an effort to develop more effective moistener and its applicator.

Water has been used as fingertip moisturizing agent for long time. Water is volatile which means it evaporates readily at room temperature, also it is easily absorbed by paper. The properties of water result a short effective period if only water is used as moisturizing agent. Under the condition of continuously handling papers such as counting money, the water applied on the surface of fingertips will be wipe out and be absorbed away by paper shortly after application. The remaining trace of water will evaporate soon and leave skin dry again. As soon as surface water evaporated the cornified epidermis of the fingertip skin become hard and slippery, and the frictional force between the skin of the fingertip and the subjects become weaker, and the separation of papers, films become harder and harder. By this time it is necessary to apply water on the skin again. The problem of using water as moisturizing agent is that water has to be applied on fingertips frequently, because most of the water on the fingers would evaporate or be wiped away by paper, before they diffuse through the cuticle into the skin.

The wax-form moisteners contain almost no water and do not essentially moisturize the skin. By applying them, the skin has a coat of wax over it. The wax enhances the frictional force but not as much water. Additionally a coat of wax on the skin can be uncomfortable.

U.S. Pat. No. 5,938,359 which issued to Kim on Aug. 17, 1999 and U.S. Pat. No. 6,152,634 which issued to Kim on Nov. 28, 2000 disclosed a sanitary moistener comprises an elongated body having a writing tip at one end and a supply of moistening liquid accessible at a location on the body of the instrument by a finger of an individual using the instrument, in order to moisten the finger to facilitate turning sheets of paper. The moistening liquid is supplied in a reservoir and delivered by a pump, or through a finger-operated valve. A liquid containing a bactericide may be preferable to water as the moistener. Also a perfume may be included in the moistening liquid. Since water has very shot effective time, the writing instrument limited by its volume may not be able to carry enough water.

U.S. Pat. No. 6,409,059 which issued to Calvert on Jun. 25, 2002 disclosed thimbles constructed to mount over the fingertips to provide non-slip gripping surfaces and improved protection at the fingertips and palm. An application of U.S. patent No. 20,010,001,883 disclosed a fingertip protector. Wearing something is another way to get non-slip gripping surface but may be uncomfortable.

### SUMMARY OF THE INVENTION

The present invention relates to a novel fingertip moistener, fingertip fluid which has more effective moistening ability and lasts longer, and its applicator which can store and apply the fingertip fluid conveniently. The fingertip fluid consists of water and chemicals. Those chemicals help water permeate the keratinized tissue on the surface of skin from outside and diffuse into skin, prevent the skin from drying and kill bacteria. The different evaporation rates of ingredients cause the change of composition and properties of the liquid. The applicator keeps unused fingertip fluid inside of supply bottle from evaporation, ejects some of fingertip fluid out to moisten user's fingertip when user presses the top of the supply bottle, and sucks the fingertip fluid into the supply bottle when the supply bottle is released.

### BRIEF DESCRIPTION OF THE DRAWINGS

In the figures:

1—cover

2—porous plastic disc

3—small opening permitting flow of air and fluid

4—upper portion of supply bottle

5—bottom portion of supply bottle

6—drainage tube

7—seal gap

8—porous plastic disc holder

9—drainage tube support

10—gap between drainage tube and top of supply bottle

11—groove on drainage tube support

FIG. 1 is view of all parts of fingertip fluid applicator includes: a cover (1), a porous plastic disc (2), an upper portion of supply bottle (4), bottom portion of supply bottle (5) and a drainage tube (6).

FIG. 2A is a sectional view of all the parts of a fingertip fluid applicator in which a drainage tube (6) is connected to the upper portion of the supply bottle (4).

FIG. 2B is a sectional view of an assembled fingertip fluid applicator from parts of FIG. 2A.

FIG. 3A is a sectional view of all the parts of a fingertip fluid applicator.

FIG. 3B is a sectional view of an assembled fingertip fluid applicator from parts of FIG. 3A in which the drainage tube (6) is held right under the opening hole (3).

FIG. 4A is a sectional view of all the parts of a fingertip fluid applicator.

FIG. 4B is a sectional view of an assembled fingertip fluid applicator from parts of FIG. 4A

### DETAILED DESCRIPTION OF THE INVENTION

When money is being counted, if two pieces of paper bills are held between fingers and twisted, where would a slide occur? We want it to occur between the bills, but it may occur between a finger and a bill. It depends on the force of static friction between the surfaces. The force of static friction between two objects is equal the force applied tangential to the surface, but only up to a critical value given by

Fₛ₍ₘₐₓ₎=KₛN

where Kₛ is the coefficient of static friction and N is the normal force which is the force of fingers in the situation we are discussing. A slide will happen between two objects where the maximum force of static friction (Fₛ₍ₘₐₓ)) is less than Fₛ₍ₘₐₓ₎ between other two objects. Since the normal force on these surfaces is same in the situation we are discussing, Kₛ the coefficient of static friction is the only variable. A slide will take place between the surfaces where Fₛ₍ₘₐₓ₎ is smaller. The coefficient of static friction depends on the surface properties of the materials of the two subjects contacting each other. The variety of surface property of material of bill or fingertip may lead an increase or a decrease of the maximum force of static friction between them.

The present invention offers fingertip fluid which can change the properties of skin surface of fingertip to enhance the coefficient of static friction between fingertips and the touching objects. It is common knowledge that wet fingers do not slide from paper. We know the main reason of object sliding between the fingertips is dryness of the skin of the fingertips. When the human body does not need reduce its temperature it will cut down the body liquid secreting from sweat gland and by the evaporation of the body liquid on surface of the skin, the cuticle will become stiff, hard, inelastic. If apply some moisturizing agent on the surface of the dried skin, the skin will become soft again. Soft skin has higher coefficient of static friction with paper and usually have a frictional force strong enough to handle slippery paper. Fingertip fluid, the moisturizing agent of the present invention has an excellent moisturizing and softening effect. It has a composition similar to the composition of human body liquid and can be absorbed by human skin rapidly. By applying it, the dried skin becomes soft again, restores its original elastic nature, at same time, and restores its original normal friction force. There are two key factors: it should ‘have composition similar to human body liquid’ and ‘be absorbable by human skin rapidly’. ‘have composition similar to human body liquid’ is important because the skin is moisturized by the human body liquid secreted from sweat gland naturally. When we use moisturizing agent to restore its original properties to the dried skin from exterior, we do want the agent ‘have composition similar to human body liquid’, to achieve the best result and avoid side effects. ‘be absorbable by human skin rapidly’ is another important property of fingertip fluid, because the fluid should be able to permeate the cuticle of the fingertip before be wiped away by paper. Human body liquid moisturizes skin through sweat gland. On the contrary, moisturizing agent must permeate the keratinized tissue on the surface of skin from outside and diffuse into skin. There is less than a second usually from the application of fingertip fluid on the fingers until they contact paper. During this short time the fingertip fluid of present invention can reach the deep tissues of the skin. The properties of the fluid are dependent on its composition.

The fingertip fluid of present invention needs a device which combines the functions of storing and applying together. Compositions of the present invention fluid are close to which of human body liquid, having large amount of evaporable liquids and small amount of materials which are solid under normal temperature. The different evaporation rates of each ingredient cause the change of composition and properties of the liquid from time to time. This probably is the main reason that no solution or colloidal suspension has been used as fingertip moisturizing agent. The present invention includes a special device which makes the fingertip fluid usable. This device, the applicator of the present invention, reduces the unwanted evaporation substantially, can be used to store the fingertip fluid safely and can apply the fingertip fluid conveniently. The said applicator includes a supply bottle with a drainage tube extending the opening hole on the top to the bottom area of the bottle, a porous plastic applicator disc attached to the top of the bottle and a flexible body portion suitable for fingers pressing to squeeze.

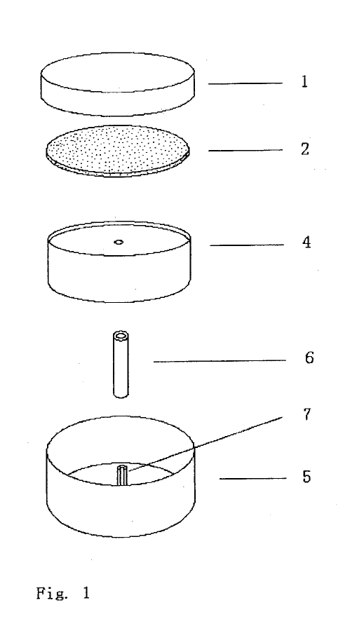

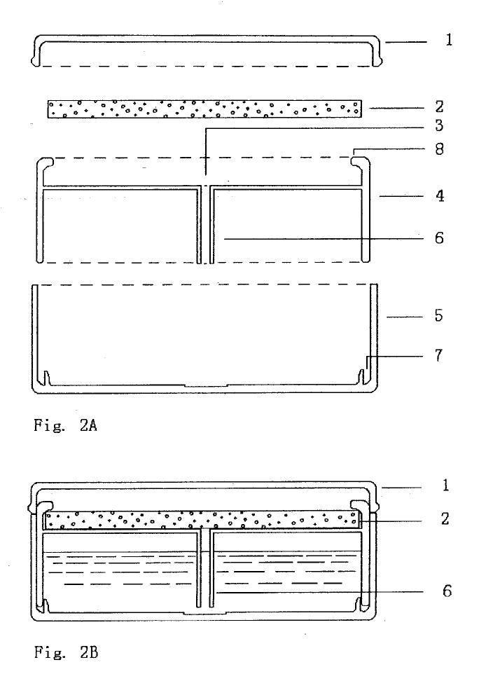

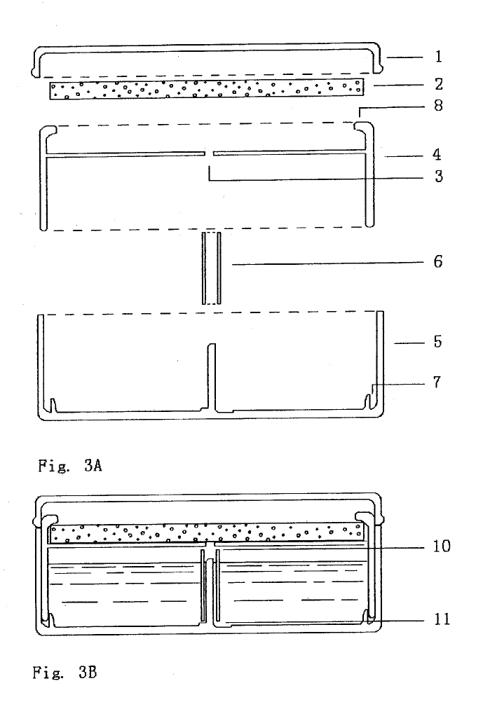

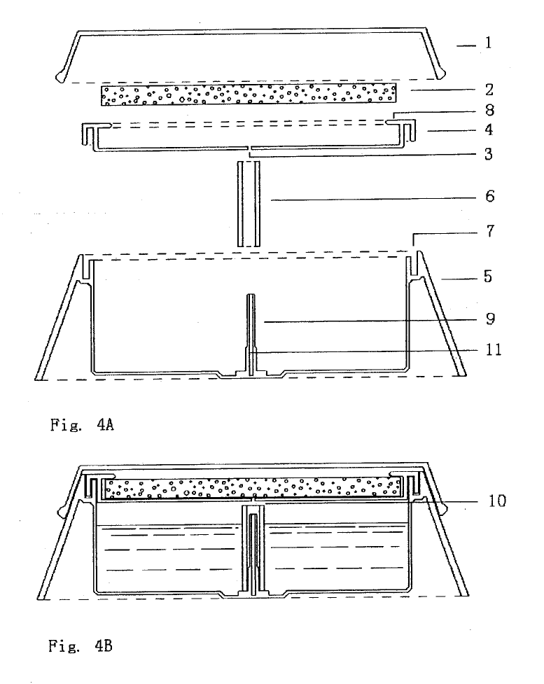

Three preferred embodiments of the fingertip fluid applicator of the present invention is illustrated in FIGS. 1 through 4. In the preferred embodiment, the fingertip fluid applicator includes a cover (1), a porous plastic disc (2), an upper portion of supply bottle (4), bottom portion of supply bottle (5) and a drainage tube (6). Supply bottle is typically of short conical or cylindrical shape. A preferred seal method is illustrated and the seal methods are not limited to this. One or more gap (7) along the side of the upper or bottom portion of the supply bottle is included that provides a secure, air impervious seal between the upper and bottom portion of the supply bottle without using adhesive or other sealing devices. There is a small opening (3) on the upper portion of supply bottle permitting flow of air and fingertip fluid. The drainage tube (6) provides a channel for fluid from the bottom of supply bottle to the opening (3) on the top of the supply bottle. FIG. 1 is a view of all the parts of a fingertip fluid applicator. FIG. 2A is a sectional view of all the parts of a fingertip fluid applicator. FIG. 2B is a sectional view of an assembled fingertip fluid applicator in which a drainage tube is connected to the upper portion of the supply bottle. The liquid inside is forced out from the bottom of the supply bottle through the drainage tube (6) and the opening hole (3) on the top of the supply bottle to the porous plastic disc (2) when the bottle is squeezed. And when the bottle is released, it allows the return of the flexible body portion substantially to its original shape and induces a partial vacuum therein which facilitates the return of fingertip fluid trapped within the applicator disc (2) interior over the top into the supply bottle. This way, present invention keep fingertip fluid inside of supply bottle from unwanted evaporation. When the pressure inside is higher than outside, the fluid inside of the bottle is forced out. It happens when the bottle is squeezed or the temperature increases or even the pressure outside decreases. FIGS. 3A and 4A are sectional views of all the parts of two more fingertip fluid applicators in which the drainage tubes (6) are not connected to the upper portion (4) of the supply bottle directly. FIGS. 3B and 4B are sectional views of these two assembled fingertip fluid applicators. In these two applicators the top portion (4) of these supply bottle and the drainage tube (6) are made of resilient material such as flexible plastic, rubber and the drainage tube is held by a tube support (9) right under the opening hole (3). A less than 2 mm narrow gap (10) between the drainage tube (6) and the top of the bottle (4) allows air passes through balancing the pressure inside the supply bottle and the pressure of atmosphere around when the atmosphere pressure or the temperature changes. The fluid is forced out from the bottom of the bottle through the groove (11) on the support (9) of drainage tube when the flexible top (4) of the bottle is pressed down and the said gap (10) is diminished to an air impervious seal stopping air passing. When the bottle is released, the flexible top portion returns substantially to its original shape inducing a partial vacuum inside which facilitates return of the fingertip fluid trapped within the applicator disc (2) interior into the supply bottle. In the preferred embodiment, the upper end of the upper portion (4) of the supply bottle includes a lot of needle shape short sticks in the area under the porous plastic disc (2) to keep the porous disc from sliding, the said sticks having 0.1 mm to 2.0 mm in diameter, 0.1 mm to 5 mm long with a density of 1 to 100 per square centimeter. In the preferred embodiment, the upper end of the upper portion (4) of the supply bottle also includes an annular flange preferably extending inwardly. The annular flange forms a wide opening can hold the porous plastic disc (2) inside. Therefore it is also called disc holder (8). The diameter of the opening is preferred about 1 mm to 20 mm small than the disc. The flange is typically circular, but may be of any ring-like shape, such as oblong or polygonal and something else, to conform to the shape of the porous plastic disc (2). The disc (2) is formed of a soft material having a porous structure to permit free flow of air and fingertip fluid. Contemporary methods may be used to sinter or fuse individual polymeric thermoplastic particles to form the porous structure of the applicator (2). Preferably, the disc (2) is formed of polyurethane foaming material having an average pore size between about 0.1 and 2.0 mm in diameter, where the pores occupy between about 70 and 98 percent of the total volume of the applicator disc. The density of the porous polyurethane material is approximately between about 0.02 and 0.4 grams/cm³, and the thickness of the disc (2) is less than about 2.0 cm., advantageously between 0.2 and 0.5 cm. When fingers push down the disc, it becomes flat but still provides channels for air and fluid escaping from supply bottle and at same time it coats the pushing down fingertips uniformly with the fingertip fluid. A plastic cap (1) seals the applicator keeping fluid from evaporation and preventing dust contamination.

The fingertip fluid of the invention, in addition to the special properties mentioned above, has the following characteristics: nontoxic, colorless, helps to maintain skin's youthful appearance and soft texture and kills most bacteria on the skin. The properties of fingertip fluid are provided by its ingredients. The ability of the applicator of present invention to keep fingertip fluid from evaporation makes it possible to use a wide range of substance which provide the properties we need. The fingertip fluid of the present invention is in the form of an aqueous mixture and consists essentially of the following ingredients, in percent by weight:

Water, more than 50%, over 90% is preferred.

Surfactants, including anionic, cationic and nonionic surfactants, less than 5% usually, 0.05% to 1.0% is preferred. Surfactants play two roles: enhancing osmotic ability of fingertip fluid and stabilizing the colloidal suspension of fingertip fluid. Nonionic surfactants are preferred because of their low irritation to skin. Typical of nonionic surfactants are monoglycerides such as glyceryl monostearate and the like; sorbitan aliphatic esters such as sorbitan monoleate and the like; polyoxyethylene aliphatic esters such as polyoxyethylene stearate and the like; sucrose aliphatic esters and polyoxyethylene higher alcohol ethers. Anionic surfactants are also preferred, but they can not be used in combination with cationic surfactants.

Alcohols, including monohydric alcohols and polyhydric alcohols, less than 50% is preferred. Alcohols can be used alone or in combination with each other. Monohydric alcohols include methyl alcohol, ethyl alcohol, propanols, butanols, amyl alcohols, hexanols, heptanals, octanols, n-dodecanol, n-tetradecanol, cetyl alcohols, stearyl alcohol and so on. Polyhydric alcohols include ethylene glycol, propylene glycol, glycerol, butanediols, sorbitan alcohol, panthenol and so on.

Esters, less than 3% is preferred. Stearate, cetearyl octancate, olive oil, corn oil, glyceryl monostearate, momoglycerides, lecithin, sorbitan aliphatic esters are are common ester used.

Hydrocarbons, like mineral oil, Vaseline and wax, less than 3% is preferred.

Organic acids and bases such as stearic acid, isostearic acid and triethanolamine can be used at the same time.

Paper bills are usually circulated among many people and may carry bacteria and virus that can cause disease. In the present invention, the fingertip fluid preferably also contains at least one kind of antibacterial agent. The amount of antibacterial agent varies on the properties of the agent. For example about 50% ethyl alcohol is needed to kill bacteria effectively, and 0.20% 2,4,4′-trichloro-2′-hydroxydiphenyl ether is strong enough to extinguish almost all kinds of bacteria immediately.

The fingertip fluid of the invention is protected against the growth of microorganisms and therefore preservatives are added. Preferred preservatives for the fingertip fluid are methyl and propyl para-hydroxybenzoates and 2-phenoxyethanol with about 0.1% to 0.5%. The preservatives should be selected having regard for the use of the composition and possible incompatibilities between the preservatives and the other ingredients in the fluid.

The compositions of the fingertip fluid of the invention will also contain one or more fragrances which are nonirritating to the skin.

In addition, it is preferred to adjust the pH of the fluid of the invention by adding organic acids or bases. The desired final pH value is 6.5 to 7.5

### EXMAPLES

The following Examples further illustrate the compositions of the fingertip fluid of the invention and are not intended to be limiting to the scope of the invention in any respect.

### Example 1

| INGREDIENTS | WEIGHT PERCENT |
|---|---|
| Triclosan | 0.05 |
| Stearic acid | 0.05 |
| Isostearic acid | 0.10 |
| Olive oil | 0.10 |
| Corn oil | 0.05 |
| Pec-100 stearate | 0.10 |
| n-Cetyl alcohol | 4.00 |
| Glycerin | 1.00 |
| Panthenol | 0.50 |
| Lanolin alcohol | 2.50 |
| Triethanolamine | 0.30 |
| 2-phenoxyethanol | 0.20 |
| Cetyl alcohol | 0.50 |
| Mineral oil | 1.00 |
| Preservative | 0.10 |
| Fragrance | 0.20 |
| Water | to 100 |

### Example 2

| INGREDIENTS | WEIGHT PERCENT |
|---|---|
| Triclosan | 0.05 |
| Isostearic acid | 1.50 |
| Olive oil | 0.10 |
| Corn oil | 0.05 |
| Pec-100 stearate | 0.50 |
| Glycerin | 5.00 |
| Panthenol | 0.50 |
| Lanolin alcohol | 0.50 |
| Triethanolamine | 0.10 |
| Cetyl alcohol | 0.10 |
| Mineral oil | 0.20 |
| Glyceryl monostearate | 1.00 |
| Preservative | 0.10 |
| Fragrance | 0.20 |
| Water | to 100 |

### Example 3

| INGREDIENTS | WEIGHT PERCENT |
|---|---|
| Triclosan | 0.05 |
| Stearic acid | 0.03 |
| Ethylene glycol | 0.50 |
| Glycerin | 5.00 |
| Triethanolamine | 0.20 |
| Cetyl alcohol | 0.50 |
| Mineral oil | 0.01 |
| Monoglycerides | 0.50 |
| Sorbitan alcohol | 1.00 |
| Fragrance | 0.20 |
| Water | to 100 |

### Example 4

| INGREDIENTS | WEIGHT PERCENT |
|---|---|
| Triclosan | 0.05 |
| Stearic acid | 0.05 |
| Olive oil | 0.10 |
| Pec-100 stearate | 0.10 |
| n-Cetyl alcohol | 2.00 |
| Glycerin | 2.00 |
| Panthenol | 2.00 |
| Lanolin alcohol | 2.00 |
| 2-phenoxyethanol | 0.20 |
| Vaseline | 1.00 |
| Fragrance | 0.20 |
| Water | to 100 |

### Example 5

| INGREDIENTS | WEIGHT PERCENT |
|---|---|
| Triclosan | 0.05 |
| Stearic acid | 0.03 |
| Isostearic acid | 0.01 |
| n-Cetyl alcohol | 1.00 |
| Glycerin | 3.00 |
| Panthenol | 0.50 |
| Lanolin alcohol | 0.50 |
| 2-phenoxyethanol | 0.20 |
| Glyceryl monohydroxy stearate | 0.75 |
| Fragrance | 0.20 |
| Water | to 100 |

### Example 6

| INGREDIENTS | WEIGHT PERCENT |
|---|---|
| Sorbitan aliphatic eaters | 0.50 |
| Propylene glycol | 2.00 |
| Monoglyceride | 1.00 |
| Triethanolamine | 0.20 |
| EDTA | 0.10 |
| Triclosan | 0.05 |
| Stearic acid | 0.50 |
| Olive oil | 0.10 |
| n-Cetyl alcohol | 1.00 |
| Glycerin | 2,00 |
| Panthenol | 0.50 |
| Lanolin alcohol | 0.50 |
| Triethanolamine | 0.10 |
| 2-Phenoxyethanol | 0.30 |
| Mineral oil | 1.00 |
| Fragrance | 0.20 |
| Water | to 100 |

We claim:

1. A device for storing fingertip fluid and coating it to user's fingertips in order to moisturize the skin of said user's fingertip, comprising:
a container for the fingertip fluid including a flexible portion and an opening hole on the center thereof which opening reaches the bottom of the container through a drainage tube,
fingertip fluid in said container, a solution or colloidal suspension which facilitates moistening and sanitizing fingertip consisting essentially of more than 50% (by weight) water and at least one of the following ingredient: saturated organic acids, unsaturated organic acids, anionic surfactants, cationic surfactants, nonionic surfactants, amines, alcohols, polyhydric alcohols, esters, hydrocarbons, antibacterial agents, preservatives and fragrances,
a porous applicator disc, substantially cylindrical with a thickness less than 2.0 cm., sitting on the top of said container covering the opening hole, for uniformly coating the user's fingertips with said fingertip fluid to moisturize the skin of the user's fingertip, wherein said porous applicator disc formed of polyurethane-foaming material having an average pore size between about 0.1 mm and about 2.0 mm in diameter, wherein the pores occupy between about 70% and about 98% of the total volume of said material, having a density approximately between about 0.02 grams/cm³ and about 0.4 grams/cm³,
1 to 100 needle shaped short sticks per square centimeter on the top surface of said container in the area under the porous disc, keeping the porous disc from sliding, the said sticks having about 0.1 mm to about 2.0 mm in diameter, 0.1 mm to 5 mm long, and
a plastic cap to keep fingertip liquid from evaporation and dust contamination.

2. The device of claim 1, wherein pressing down the top of said container, the fingertip fluid stored inside is forced out from the bottom of the container through the drainage tube and the opening hole to the porous applicator disc on the top of the container, and when the container is released, the flexible body portion of the container returns substantially to its original shape inducing a partial vacuum therein which facilitates return of fluid from the applicator disc into the container keeping the fluid from evaporation,

3. The device of claim 1, wherein the top portion of the container and the drainage tube are made of elastic material selected from the group consisting of rubber, Gum rubber, Latex rubber, PE, PP, EVA, PET, PBT, PVC, PS, ABS, PC, PA, Silicone, Teflon and Tygon, and the drainage tube is held right under the opening hole with a less than 2 mm gap between the top portion of the container and the drainage tube, said gap allows air passing through to balance pressure inside and outside of the container, wherein when pressing down the flexible top of the container, said gap is diminished to a air impervious seal stopping air passing, and the liquid inside the container is forced out from the groove in the bottom of the container through drainage tube and the opening hole to the applicator disc on the top of the container.

4. The device as defined in claim 1, wherein the porous applicator disc, substantially cylindrical, is held on the top of the container covering the opening hole by an annular flange which forms an opening, which is about 1 mm to about 20 mm smaller in diameter than the applicator disc, said flange is circular, or any ring-like shape, which shape may be oblong or polygonal, to conform to the shape of the porous applicator disc.
